(19) United States
(12) Patent Application Publication
(10) Pub. No.: US 2025/0040627 A1
(43) Pub. Date: Feb. 6, 2025

(54) GARMENT WITH PADDING AND CORRESPONDING PRODUCTION METHOD

(71) Applicant: CYTECH S.R.L., SAN VENDEMIANO (IT)

(72) Inventors: Denis BERTOLDO, FIUME VENETO (IT); Enrico CAMPARI, BOLOGNA (IT); Laura MAZZOCCHETTI, BOLOGNA (IT); Luigi ANGIOLINI, BOLOGNA (IT); Niccolò GIANI, BOLOGNA (IT)

(73) Assignee: CYTECH S.R.L., SAN VENDEMIANO (IT)

(21) Appl. No.: 18/697,256

(22) PCT Filed: Sep. 29, 2022
(86) PCT No.: PCT/IT2022/050265

§ 371 Date: Mar. 29, 2024

(30) Foreign Application Priority Data
Sep. 30, 2021 (IT) 102021000025082

(51) Int. Cl. A41D 1/084; B29C 64/118; B29C 64/124; B29C 64/153; B29K 21/00; B29L 31/00; B29L 31/48; B33Y 10/00; B33Y 80/00

(52) U.S. Cl. CPC A41D 1/084; B29C 64/118; B29C 64/124; B29C 64/153; B33Y 10/00; B33Y 80/00; B29K 2021/003; B29L 2031/4857; B29L 2031/4864; B29L 2031/768

(57) ABSTRACT

Padding (10) produced by means of 3D printing and comprising a multi-plane structure (11) comprising a plurality of overlapping layers (12), each of which is defined by an alternation of solids and voids, wherein the plan view conformation of each of said layers (12) is made according to at least one open and/or closed pattern, and in that said plan view conformation is variable.

### FIELD OF THE INVENTION

The present invention concerns a padding and the corresponding method for producing it. The padding according to the present invention can be used preferably, but not exclusively, to make protective elements as well as sports garments, such as for example chamois for cyclists, gloves, helmets, insoles, or suchlike.

### BACKGROUND OF THE INVENTION

In the sports field, it is known to use protective elements that comprise one or more paddings in order to improve the comfort and safety of athletes.

For example, in cycling and horse riding, it is known to use shorts that comprise one or more paddings, located in the part astride the legs, in order to protect the zone of the body that during sports activity is in contact with the saddle, and therefore subjected to continuous friction and compression stresses. These shorts, or their portion that comprises the padding, are called “chamois” or “pads” in jargon.

Gloves are also known, for example used in cycling or motorcycling, which comprise at least one padding, located in correspondence with the palm of the hand in contact with the handlebar grips, which considerably improve comfort during sports activity and reduce the risk of problems arising, for example with the skin of the hand, due to rubbing with the handlebar grips as above.

These paddings are generally made of polyurethane foam, for example by overlapping and gluing two or more layers of foam that have different densities and/or thicknesses.

These paddings have a spongy structure, comprising bubbles that form during the expansion of the foams.

During sports activity, in the zone where the skin is in contact with such paddings, the temperature is high due to the rubbing and the almost total absence of heat exchange.

This causes a high level of sweating and consequently the onset of skin irritation and the proliferation of bacteria. The particular conformation of the polyurethane foams prevents good ventilation, even if low density foams are used.

It is also known that one of the characteristics of such paddings is that during deformation they have a first elastic resistance zone in which the deformation is lower than about 10%. This first resistance zone is followed by a second zone with progressive yielding to almost constant load, until the paddings reach a deformation of about 50%, this second zone is characterized by the collapse of the bubble structure. Subsequently, the material begins to have an elastic response that is very similar to that of a solid material.

Therefore, producing paddings with thicknesses and stiffnesses that vary from point to point is particularly complicated if these are made of polyurethane foam.

This, together with the cutting, assembly and gluing of the various portions requires high precision and long processing times, which result in high costs, without any guarantee that the mechanical properties of the paddings will meet project specifications.

US2020/390169A describes a protective glove that has a padding made by means of 3D printing.

WO2020/232555A1 describes a protective helmet for hockey players that has an internal padding made by means of additive printing techniques.

The solutions described in these documents mainly concern paddings which are associated with rigid components and do not themselves act as a bearing and support structure suitable to protect a part of a user's body from stresses that are constant and prolonged over time.

There is therefore the need to perfect a padding that can overcome at least one of the disadvantages of the state of the art.

To do this, it is necessary to resolve the technical problem of producing a padding for protective elements that has zones with different resistances, which ensures high breathability and guarantees a high level of comfort for the user.

In particular, one purpose of the present invention is to provide a padding, and the corresponding method, which has a high elastic response and zones with differentiated resistance.

Another purpose of the present invention is to provide a padding that has high breathability.

Another purpose of the present invention is to produce paddings that do not need to be assembled, so as to improve their durability over time and reduce processing scraps and waste.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the above technical problem in a new and original way, also obtaining considerable advantages compared to the state of the prior art, a padding according to the present invention is produced by means of 3D printing.

In accordance with one aspect of the present invention, the padding comprises a multi-plane structure comprising a plurality of overlapping layers, each of which is defined by an alternation of solids and voids, wherein the plan view conformation of each of the layers is made according to at least one open and/or closed pattern.

In accordance with another aspect, the plan view conformation of each of the layers is variable.

In accordance with another aspect of the present invention, the plan view conformation is variable at least as a function of the height of the structure, so as to create a plurality of zones that have different mechanical properties.

Doing so achieves at least the advantage of obtaining a padding that has zones with different mechanical characteristics.

In accordance with another aspect of the present invention, the cross section conformation of the structure, obtained in a direction perpendicular to the plan view, has a plurality of solids and voids disposed in an irregular manner. Such cross section conformation is also variable at least as a function of the zone and of the structure.

In accordance with another aspect of the present invention, the 3D printing is a printing by deposition of a filament made of thermoplastic elastomer material (TPE).

Such filament can also be made with materials of natural origin, recycled materials, or both. In accordance with another aspect of the present invention, the open and/or closed pattern is a linear, with rings or polygonal pattern.

Furthermore, the number of layers of one of the zones is different from the number of layers of at least another of the zones.

According to some embodiments, the zones comprise a plurality of layers overlapping each other that have a plan view conformation with rings, and/or a plurality of layers that have a plan view conformation with hexagons and a plurality of layers that have a linear plan view conformation, wherein the number of layers of a certain type and the order of the layers in at least one zone is different from the number and order of the layers in another zone.

In accordance with another aspect of the present invention, the padding comprises an external perimeter zone that has an external edge the height of which is lower than the height of at least one central zone, and the variability of the height from such perimeter zone to such central zone can be in a constant or non-constant progression.

In accordance with another aspect of the present invention, a method for producing a padding by means of 3D printing provides to define a multi-plane structure comprising a plurality of overlapping layers, each of which is defined by an alternation of solids and voids, wherein the plan view conformation of each of the layers is made according to at least one open and/or closed pattern; moreover, the plan view conformation of each of such layers is variable.

In accordance with another aspect of the present invention, a sports garment comprises at least one padding as described above and/or a padding made by means of a method as described above.

In accordance with another aspect of the present invention, the sports garment is a chamois, a glove or a pair of shorts.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is an exploded schematic view of a padding according to the present invention;

FIG. 2 is a perspective and schematic view of the padding of FIG. 1;

FIG. 3 is a top view of a padding according to the present invention in accordance with a second embodiment;

FIG. 4 is a lateral section view of the padding of FIG. 3;

FIG. 5 is a detail of FIG. 4;

FIG. 6 is a perspective view of a padding according to the present invention in accordance with a third embodiment;

FIG. 7 is a perspective and schematic view of a padding according to the present invention in accordance with a fourth embodiment;

FIG. 8 is a perspective and schematic view of a padding according to the present invention in accordance with a fifth embodiment.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

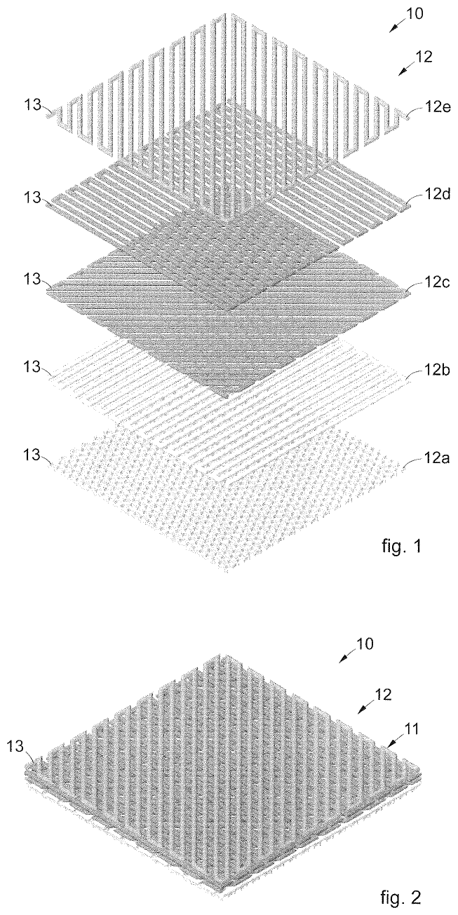

With reference to FIG. 1, a padding 10 according to the present invention comprises a multi-plane structure 11 obtained by overlapping a plurality of layers 12.

The padding 10 can be produced by means of any 3D printing method whatsoever, for example sintering, or additive printing by deposition of a filament 13, or printing by polymerization of a photosensitive resin.

Sintering, also known as selective laser sintering (SLS), is an additive manufacturing process that uses a laser to sinter a powder material, specifically a polymer material configured to melt and bond when the laser is pointed at it.

Additive printing by deposition of a filament, also known as FDM (Fused Deposition Modeling) or FFF (Fused Filament Fabrication) uses a continuous filament 13 of thermoplastic material.

Printing by polymerization of a photo-sensitive resin, also known as DLP (Digital Light Processing) or SLA (stereolithography printing) provides to selectively expose a liquid resin to a source of light, specifically a projector for DLP and a laser for SLA.

The filament 13 used for the additive printing can be made, for example, of thermoplastic elastomer material (TPE), or any other material suitable for contact with a person's skin without causing irritation or problems of a different nature.

The use of thermoplastic elastomer materials is preferred, since these are chemically similar to polyurethane foam and they have the same degree of compatibility for contact with the skin, consequently their use is particularly advantageous.

For example, the thermoplastic elastomer materials used could have a hardness, comprised between 40 Shore A and 95 Shore A, preferably comprised between 50 Shore A and 90 Shore A, even more preferably comprised between 60 Shore A and 80 Shore A.

In addition, the use of these materials easily allows to add substances with antibacterial, anti-inflammatory and soothing properties.

In the case of SLS, DLP or SLA printing, it is possible to use, respectively, polymeric powders or photosensitive polymeric resins suitable to allow contact with the skin of a user.

FIG. 1 shows, by way of example, a schematic representation of the first layers 12, respectively 12a, 12b, 12c, 12d and 12e, of the padding 10.

According to possible embodiments, not shown in the attached drawings, each layer 12 can be made by means of additive printing by deposition of at least one second filament.

For example, each of the layers 12 could comprise a portion made with the first filament 13 and at least a second portion made with the second filament.

The second filament used for the additive printing can be made of the same material with which the first filament 13 is made or, for example, with a different thermoplastic elastomer material.

This can be, for example, a filament for 3D printing that has a hardness, in terms of Shore A, different from the hardness of the first filament 13, as will be better described below.

Each layer 12 can be made by deposition of the filament 13 according to a specific pattern of deposition, for example open or closed.

Here and hereafter in the description, by pattern, or pattern of deposition, we mean the particular trajectory followed by the nozzle with which the filament 13 is deposited, and consequently, the geometric structure of the filament 13 once it is solidified after printing.

In the case of 3D printing processes by means of sintering, stereolithography or digital light processing, the conformation of the single layer is determined, instead of by the filament itself, by the laser or the light to which the polymeric powder or the photosensitive resin, respectively, is exposed. In any case, each layer 12 will have a specific pattern of deposition, different from the previous and subsequent layer, so as to create an alternation of solids and voids.

For example, the open pattern of deposition could be linear, as represented in layers 12b, 12c, 12d and 12, and the closed pattern could be with rings or polygonal, for example with a hexagonal pattern (layer 12a of FIG. 1), a triangular or square pattern.

Each layer 12 could be made with multiple patterns of deposition, for example, one of the layers 12 (not shown in the drawings) could have one portion made with a pattern with rings, one portion made with a linear pattern and one portion made with a hexagonal pattern. In this way, each layer 12 could have portions with different mechanical properties from each other, as will be better described hereafter in the description.

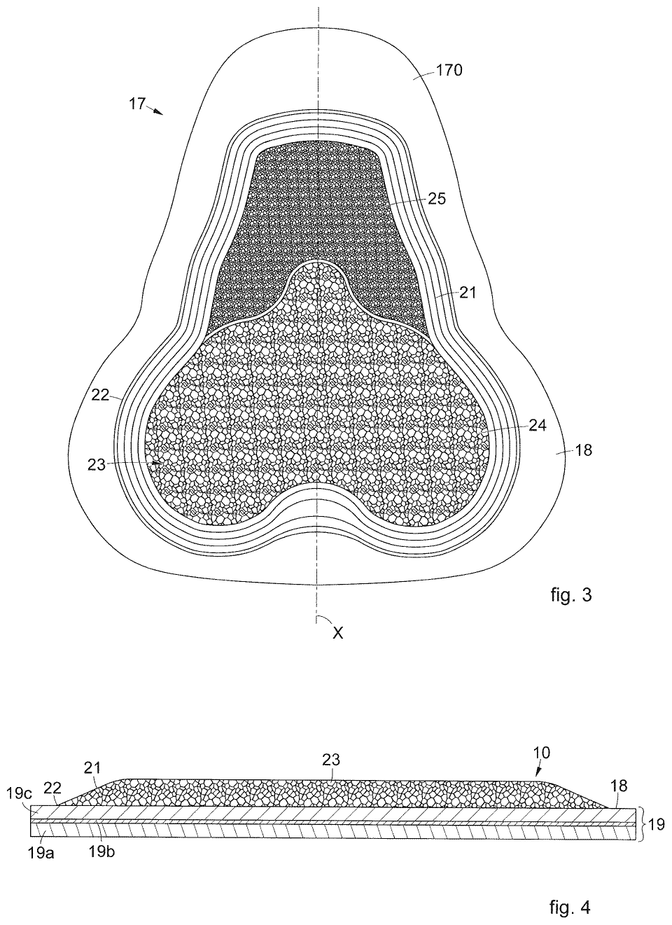

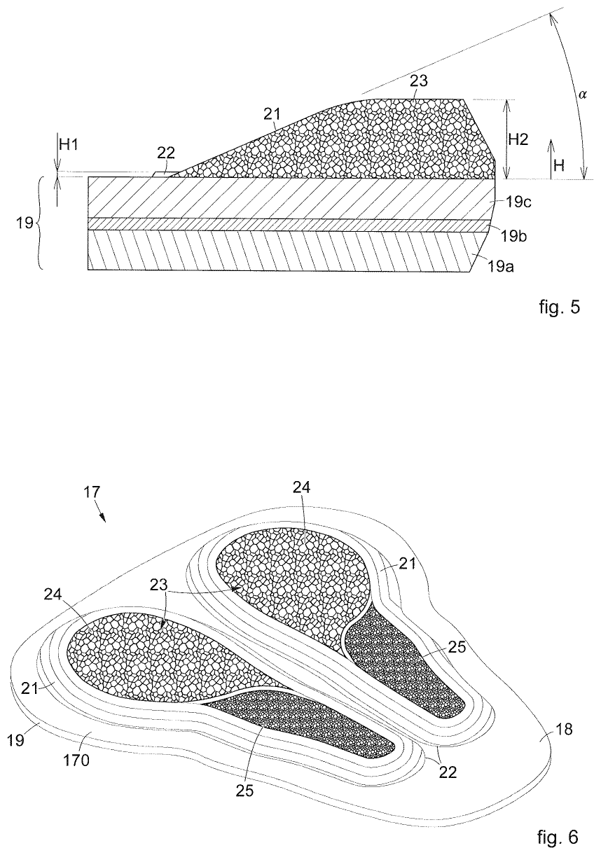

The plan view conformation of each of the layers 12, obtained in a direction parallel to the longitudinal axis X of FIG. 3, can be regular or irregular according to the pattern or to the combination of patterns used to define its geometry, even three-dimensional.

Each layer 12a, 12b, 12c, 12d and 12e can be made with a pattern of deposition, and consequently a plan view conformation, different from the layer 12e, 12d, 12c, 12b and 12a that immediately follows it (above or below it).

According to some embodiments, a plurality of layers 12 with a linear pattern (for example the layer 12e of FIG. 1), in which the pattern of deposition is parallel to the longitudinal axis X, could be alternated with a plurality of layers 12 with a linear pattern 12d and 12c, in which the pattern of deposition is not parallel to the longitudinal axis X and is therefore inclined, for example by 45°, with respect thereto.

According to possible embodiments, the structure 11 can comprise a layer 12e made with a pattern of deposition different from the pattern of deposition of at least another layer 12a.

The structure 11 could comprise a plurality of contiguous layers 12 made with the same pattern of deposition, for example alternating with an additional plurality of layers 12 made with a pattern of deposition different from each other.

Therefore, the plan view conformation of the layers 12 is variable at least as a function of the height H of the structure 11, so as to create a plurality of zones 24 and 25 that have different mechanical properties, such as the elastic modulus, stiffness and resistance, for example.

The structure 11 could comprise a plurality of layers 12 made with a polygonal pattern, for example hexagonal, alternating with a plurality of layers 12 made with a linear pattern, parallel to each other or inclined with respect to a particular direction of deposition, alternating with an additional plurality of layers 12 that have a polygonal pattern.

According to some embodiments, the height, or thickness, of each layer 12 is comprised between 0.05 mm and 2 mm, preferably between 0.1 mm and 1 mm, even more preferably between 0.1 mm and 0.5 mm.

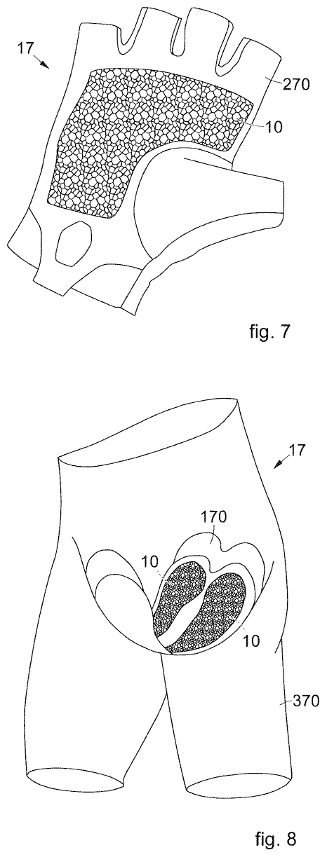

According to some embodiments, the padding 10 can be associated with a sports garment 17 (FIGS. 3, 6, 7 and 8), for example, the padding 10 could be associated with a chamois 170 (FIGS. 3, 7 and 8), with a glove 270 (FIG. 7), with a pair of shorts 370 (FIG. 8), with a helmet, with an insole but also with knee and elbow pads.

The chamois 170 (FIGS. 3 and 6) could be produced by associating a padding 10 with a portion of fabric 18 (FIGS. 3 and 4) configured to be subsequently associated with, or located in, the crotch portion of a pair of sports shorts 370 (FIG. 8).

The portion of fabric 18 (FIGS. 3 and 4) can comprise a plurality of layers 19 made of different materials which are configured to improve the comfort and breathability of the chamois 170 during its use.

For example, the portion 18 could comprise a first layer 19a made of fabric, natural or synthetic material, a second layer 19b of foam and a third layer 19c of jersey.

The layers 19 can be coupled using methods that provide to use flames or glues.

According to possible embodiments, not shown in the attached drawings, the portion 18 can be made in a single layer 19, also called “in a single body”, for example made of layered material, comprising a plurality of materials inside it, such as polyester, polyamide, or polyurethane, for example.

According to some embodiments, the portion of fabric 18 comprises polyurethane or its derivatives.

According to some embodiments, the padding 10 can be associated with the portion 18 by means of any known association method whatsoever.

According to possible embodiments, the padding 10 could be printed directly onto the portion of fabric 18, as described in a correlated patent application for industrial invention filed by the same Applicant of the present patent application.

The padding 10 can comprise an external perimeter zone 21, which has an external edge 22 the height H1 of which tends to zero, and at least one central zone 23, continuous to the external perimeter zone 21, which has a height H2 greater than the height H1 of the external edge 22.

The height H of the padding 10 increases linearly from the external perimeter zone 21 to the at least one central zone 23. In this way, the comfort and fit of the sports garment 17 are improved.

The ratio between H1 and H2 is such that the angle α, which represents the inclination of the external perimeter zone 21, is comprised between 30° and 70°, preferably between 40° and 65°, even more preferably between 45° and 60°.

The height H2 of the central zone 23 can have a value comprised, for example, between 0.2 mm and 30 mm, preferably between 4 mm and 15 mm, even more preferably between 6 mm and 12 mm.

Furthermore, the zones 24 and 25, which have different mechanical properties, such as the elastic modulus for example, can be comprised in the central zone 23.

This can be achieved by making the various layers 12 of the zones 24 and 25 with different patterns of deposition from each other.

For example, the zone 24 can be made by overlapping with each other a plurality of layers 12 that have a hexagonal plan view conformation and a plurality of layers 12 that have a linear plan view conformation.

In this way, the elastic modulus, the elastic response and other mechanical properties will depend on the particular structure 11 made by overlapping the different layers 12 with each other, and on the material with which the filament 13 is made.

The zone 24 could be made by overlapping with each other a plurality of layers 12 that have a plan view conformation with rings, a plurality of layers 12 that have a plan view conformation with hexagons and a plurality of layers 12 that have a linear plan view conformation.

The zone 25 could also be made by overlapping with each other a plurality of layers 12 that have a plan view conformation with rings and/or a plurality of layers 12 that have a plan view conformation with hexagons and a plurality of layers 12 that have a linear plan view conformation. The number of layers 12 of each type and/or their order may be different from those provided in the zone 24, as a function of the mechanical characteristics and properties to be achieved.

However, it is not excluded that in the event that the two zones have to perform the same or a similar function, the number and order of the layers 12 could also be the same.

The zone 24 could be made with a thermoplastic material different from that used to make the zone 25; for example, the two materials could have a different hardness.

In this way, the structure 11 of the zone 24 will be different from that of the zone 25, and these can be designed to better resist stresses.

For example, the chamois 170 could comprise a zone 24 that is more rigid and compact than the zone 25, its shape could be configured to adapt to the ischial-perineal zone of the user and dampen the stresses on this part of the body more.

Furthermore, the padding 10 could comprise portions, or zones, made with a number of layers 12 different from each other. For example, the zone 24 could be made with a number of layers different from the number of layers 12 with which the zone 25 is made.

In this way, as well as modifying the plan view conformation of each layer 12, the filament 13 creates a structure 11 in which the cross section conformation (FIG. 4), obtained in a direction perpendicular to the longitudinal axis X of FIG. 3 and therefore in a direction perpendicular to the plan view conformation, also has a plurality of solids and voids disposed in an irregular manner.

The amount of material, due to the deposition of the filament 13, and the particular disposition of the voids will characterize the final shape of the padding 10, its structure 11 and its mechanical properties.

In addition, the presence of numerous voids will facilitate the passage of air during use, improving comfort and breathability, allowing for a better thermal flow and decreasing the proliferation of bacteria.

The conformation of the structure 11 allows for a better compressive strength, decreasing the possibility of yields occurring caused by the peak load, also known as the “buckling effect”, in the padding 10.

The padding 10 can be made in a single body (FIGS. 2, 3 and 7); moreover, according to some embodiments, it can be made in several portions associated with each other (FIG. 6), for example to allow a better adaptation to the shapes of the user's body.

According to one possible embodiment, the padding 10 shown in FIG. 7, made in a single body, can be associated with a glove 270, disposed on the portion of the palm of the hand.

Furthermore, the padding 10 can be associated with a pair of shorts 370 (FIG. 8), for example cycling shorts, in the crotch portion.

In particular, in the crotch portion, the pair of shorts 370 can have an external surface which, during use, is positioned in contact with a bicycle saddle and an opposite internal surface which, during use, is at least partly in contact with the skin of a user and the padding 10 is associated with the internal surface.

According to some embodiments, the padding 10 is positioned on the internal surface.

According to possible variants, the padding 10 is disposed in an intermediate position between the external surface and the internal surface.

The padding 10 could be directly associated with the pair of shorts 370, or it could be associated with the portion of fabric 18 and subsequently associated with the pair of shorts 370.

According to some embodiments, a method for producing a padding 10 by means of 3D printing provides to define a multi-plane structure 11, comprising a plurality of overlapping layers 12, each of which is defined by an alternation of solids and voids.

The plan view conformation of each of the layers 12 is made according to at least one open and/or closed pattern. Such plan view conformation of each of the layers 12 is variable.

The 3D printing can be a printing by deposition of filament 13 which is made of thermoplastic elastomer material (TPE).

According to some embodiments, the pattern that, in the method, defines the plan view conformation of one of the layers 12 is different from the pattern that defines the plan view conformation of at least another of the layers 12.

Advantageously, the padding 10 and the method described to obtain it, allow to obtain a structure 11 which, in association with the materials chosen to produce it, allows to eliminate the constant load yielding zone typical of known paddings.

This greatly improves the comfort, breathability, elastic behavior and recyclability of the padding 10, also increasing the sense of softness perceived by the user during its use.

It is clear that modifications and/or additions of parts may be made to the padding 10 and to the method as described heretofore, without departing from the field and scope of the present invention, as defined by the claims.

It is also clear that, although the present invention has been described with reference to some specific examples, a person of skill in the art shall certainly be able to achieve many other equivalent forms of paddings and methods for producing such paddings, having the characteristics as set forth in the claims and hence all coming within the field of protection defined thereby.

In the following claims, the sole purpose of the references in brackets is to facilitate the reading of the claims and they must not be considered as restrictive factors with regard to the field of protection defined thereby.

1: Padding (10) produced by means of 3D printing, characterized in that it comprises a multi-plane structure (11) comprising a plurality of overlapping layers (12), each of which is defined by an alternation of solids and voids, wherein the plan view conformation of each of said layers (12) is made according to at least one open and/or closed pattern, and in that said plan view conformation is variable.

2: Padding (10) as in claim 1, characterized in that said plan view conformation of each of said layers (12) is variable at least as a function of the height (H) of said structure (11), so as to produce a plurality of zones (24, 25) having different mechanical properties with respect to each other.

3: Padding (10) as in claim 1, characterized in that the pattern that defines the plan view conformation of one of said layers (12) is different from the pattern that defines the plan view conformation of at least another of said layers (12).

4: Padding (10) as in claim 1, characterized in that the cross section conformation of said structure (11), obtained in a direction perpendicular to said plan view, has a plurality of solids and voids disposed in an irregular manner, and in that said cross section conformation is variable at least as a function of said zone (24, 25) of said structure (11).

5: Padding (10) as in claim 1, characterized in that said 3D printing is a printing by deposition of a thermoplastic elastomer material (TPE).

6: Padding (10) as in claim 1, characterized in that said open and/or closed pattern is a linear, with rings or polygonal pattern.

7: Padding (10) as in claim 1, characterized in that the number of said layers (12) of one of said zones (24, 25) is different from the number of said layers (12) of at least another of said zones (25, 24).

8: Padding (10) as in claim 1, comprising an external edge (22) and at least one central zone (23), characterized in that said height (H) increases linearly from said external edge (22) to said at least one central zone (23).

9: Padding (10) as in claim 8, characterized in that in correspondence with said external edge (22) it has a first height (H1) and in correspondence with said central zone (22) it has a second height (H2), wherein the ratio between said heights (H1, H2) is such that an angle (α), which represents the inclination of an external perimeter zone (21), is comprised between 30° and 700, preferably between 40° and 65°, even more preferably between 45° and 60°.

10: Padding (10) as in claim 1, characterized in that said structure (11) comprises a plurality of layers (12) made with a polygonal pattern, alternating with a plurality of layers (12) made with a linear pattern, which are parallel to each other or inclined with respect to a particular direction of deposition, alternating with an additional plurality of layers (12) having a polygonal pattern.

11: Padding (10) as in claim 2, characterized in that said zones (24, 25) comprise, overlapping each other, a plurality of layers (12) having a plan view conformation with rings and/or a plurality of layers (12) having a plan view conformation with hexagons and a plurality of layers (12) having a linear plan view conformation, wherein the number of layers (12) of a certain type and the order of said layers (12) in at least one zone (24) is different from the number and order of said layers (12) in another zone (25).

12: Method for producing a padding (10) by means of 3D printing, characterized in that it provides to define a multi-plane structure (11) comprising a plurality of overlapping layers (12), each of which is defined by an alternation of solids and voids, wherein the plan view conformation of each of said layers (12) is made according to at least one open and/or closed pattern, and in that said plan view conformation is variable.

13: Method as in claim 12, characterized in that said 3D printing is a printing by deposition of a filament (13) made of thermoplastic elastomer material (TPE).

14: Method as in claim 12, characterized in that said 3D printing is a printing by selective laser sintering (SLS).

15: Method as in claim 12, characterized in that said 3D printing is a printing by means of polymerization of photosensitive resin chosen between DLP (Digital Light Processing) or SLA (stereolithography printing).

16: Method as in claim 12, characterized in that the pattern that defines said plan view conformation of one of said layers (12) is different from the pattern that defines said plan view conformation of at least another of said layers (12).

17: Sports garment (17), characterized in that it comprises at least one padding (10) as in claim 1 and/or a padding (10) made by means of a method.

18: Sports garment (17) as in claim 17, characterized in that said sports garment (17) is a chamois (170), a glove (270), a knee pad or an elbow pad.

19: Sports garment (17) as in claim 17, characterized in that said sports garment (17) is a pair of shorts (370) comprising, in correspondence with the crotch portion, an external surface suitable to be positioned, during use, in contact with a bicycle saddle, and an opposite internal surface which, during use, is at least partly in contact with the skin of a user, wherein said padding (10) is associated with said internal surface.
